(19) United States
(12) Patent Application Publication
(10) Pub. No.: US 2008/0025507 A1
(43) Pub. Date: Jan. 31, 2008

(54) SECURE FILE CONVERSION AND MULTIMEDIA SAMPLER PROCESSING

(76) Inventor: Stephen F. Taylor, Virginia Beach, VA (US)

Correspondence Address: STRATEGIC PATENTS P.C.., C/O PORTFOLIOIP, P.O. BOX 52050, MINNEAPOLIS, MN, 55402, US

(21) Appl. No.: 11/556,579

(22) Filed: Nov. 3, 2006

Related U.S. Application Data
(63) Continuation-in-part of application No. 11/470,244, filed on Sep. 5, 2006.
Application No. 11/470,244 is a continuation-in-part of application No. 11/552,910, filed on Oct. 25, 2006.
(60) Provisional application No. 60/714,102, filed on Sep. 2, 2005.
(60) Provisional application No. 60/726,726, filed on Oct. 14, 2005.
(60) Provisional application No. 60/730,229, filed on Oct. 25, 2005.
(60) Provisional application No. 60/733,962, filed on Nov. 4, 2005.
(60) Provisional application No. 60/733,961, filed on Nov. 4, 2005.

(51) Int. Cl. H04N 7/167

(52) U.S. Cl. 380/201

(57) ABSTRACT

Improved capabilities are described for taking a source digital file that is protected with a digital rights management facility, and converting the digital file into a file format suitable for use by a target application. In this case the target file format is different from the original file format of the source digital file, and the target application does not support the digital rights management facility of the source digital file. In addition, the file conversion process is performed in a secure processing facility that is supported by the target application.

### CROSS-REFERENCE TO RELATED APPLICATIONS

This application claims the benefit of U.S. patent application Ser. No. 60/733,962 filed on Nov. 4, 2005 and U.S. application Ser. No. 60/733,961 filed on Nov. 4, 2006.

This application is a continuation-in-part of U.S. application Ser. No. 11/552,910 filed on Oct. 25, 2006 and U.S. application Ser. No. 11/470,244 filed on Sep. 5, 2006, which also claims the benefit of U.S. application Ser. No. 60/714,102 filed on Sep. 2, 2005, U.S. application Ser. No. 60/726,726 filed on Oct. 14, 2005, and U.S. application Ser. No. 60/730,229 filed on Oct. 25, 2005.

Each of the foregoing applications is incorporated by reference in its entirety.

### BACKGROUND

1. Field

This invention relates to the field of computer file transfers, and more particularly to the transfer and use of DRM-wrapped media files.

2. Description of the Related Art

Digital Rights Management (DRM) includes any of several well-known digital file technologies used to control access to and usage of digital data such as software, music, movies, and the like. One common implementation employs a digital envelope, also referred to as a wrapper, over a computer data file to be transferred. The DRM wrapper restricts use of the file, which among other things, can protect the rights of copyright holders against unauthorized duplication or use of the underlying media. The DRM wrapper may also specify usage restrictions, such as a limited number of uses, a limited number of transfers, different modes of payment, or the like.

The manager of a DRM typically creates a secure, proprietary DRM design. The DRM design specifies the physical format and protocols to be used with the DRM wrapper, as well as the set of usage restrictions imposed. For example, most Internet music stores employ DRM to restrict the usage of music purchased and downloaded online. There are many options for consumers buying digital music over the Internet, in terms of both media vendors and purchase options. Apple's iTunes Store allows users to purchase a track online, to burn the song to an unlimited number of CDs, and transfer it to an unlimited number of Apple player devices. The purchased music files are encoded as advanced audio coding (AAC), a lossy digital audio compression standard, and wrapped in an Apple proprietary DRM called Fairplay. Apple also reserves the right to alter its DRM restrictions on the music a user has downloaded at any time. For example, Apple once decided to change the number of times a user can copy a playlist from ten to seven. Additional restrictions include songs played on only five computers at a time, and users not being able to edit or sample the songs they have purchased.

Another example of a proprietary DRM design is the Napster music store, which offers a subscription-based approach to DRM alongside permanent purchases. Users of the subscription service can download and stream an unlimited amount of music encoded to Windows Media Audio (WMA), while subscribed to the service. But as soon as the user misses a payment the service renders all music downloaded unusable. Napster also charges an additional monthly fee to users who wish to use the music on their portable device, or for each track a user burns to CD, or listens to after the subscription expires. Songs bought through Napster may be played on players carrying the Microsoft PlaysForSure logo, which currently excludes Apple player devices. In turn, Apple player devices currently exclude the ability to play songs purchased through Napster, which uses a different DRM.

The various services are currently not interoperable, that is, Apple purchased songs are wrapped in an Apple-proprietary DRM and cannot be played on other DRM-enabled devices such as Microsoft PlaysForSure, and Napster-purchased songs that are wrapped in a Microsoft-proprietary DRM cannot be played on other DRM-enabled devices such as the iPod Apple player device. The Apple and Napster DRM example is but one specific example of the incompatibility of different proprietary DRM designs. DRM designs may be used to protect the ownership rights of any computer digital data file, including music, video, audio, software, applications, databases, data files, and the like. Each DRM design is proprietary, and secured to prevent tampering.

There remains a need for an improved digital rights management system.

### SUMMARY

Provided herein are methods and systems for taking a source digital file that is protected with a digital rights management facility and converting the digital file into a file format suitable for use by a target application. It is assumed that target file format is different from the original file format of the source digital file, and that it does not support the digital rights management facility of the source digital file. In addition, the file conversion process is performed in a secure processing facility that is supported by the target application.

The conversion can accommodate target applications that do not support the encryption and/or use control structure of the digital file before conversion. The conversion preserves the rules mandated by the digital rights management layer of the digital file before conversion by providing secure transfer, providing secure processing, and by limiting the usage of the original digital file before conversion. The secure digital conversion process is associated with BIOS-level control, where the BIOS-level control limits access to the processes, parameters, and data of the digital files undergoing conversion.

Digital rights management may be applied to any digital file, where ownership rights are of concern. Where the invention disclosed herein uses media files as an example, the invention is applicable to any digital file. Ownership rights are often a concern for media files, and so the invention is well suited for this application. Media files may be a music file, a video file, an audio file, a data file, a database file, an applications file, a software file, or the like.

The systems and methods described herein further allow a user to sample a portion of a converted file under control of the secure processing facility. The purpose of this sampling is to allow a user to trial a media file as part of a potential purchase. An example of this may be a try-before-you-buy scheme for an on-line music store. The processing of the sample may utilize voice-overs inserted into the audio, or band-limit the playback, in order to provide a sample of the song without providing the full quality of the product. Implementation of this sampling may involve dynamic processing at run-time.

These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE FIGURES

The invention and the following detailed description of certain embodiments thereof may be understood by reference to the following figures:

FIG. 1 depicts the overall architecture of the preferred embodiment.

FIG. 2 depicts the top-level operation of the SCP.

FIG. 3 depicts the SCP as it applies to Apple iTunes and iPod.

FIG. 4 depicts the top-level architecture of the SSP process.

FIG. 5 depicts NRM processes related to sampler play.

FIG. 6 depicts an example 30-second sampler composite file.

FIG. 7 depicts the steps in the insertion of voiceover into an audio sampler file.

FIG. 8 depicts the signal processing steps in the insertion of voiceovers.

FIG. 9 provides an example of the parameters that govern sampler voiceover insertion.

### DETAILED DESCRIPTION

As described in greater detail below, the systems and methods disclosed herein provide secure conversion of DRM-wrapped media files to incompatible applications. The procedure, called secure conversion processing (SCP), enables the conversion of a DRM-protected file form its native encoding and encryption format, to a format compatible with the operation of other desktop media player applications, such as and including Apple iTunes. SCP also applies to any application where the native encoding and encryption format of the subject media file (audio or video) is incompatible with the decoding and decryption requirements of the target application. Note that references to iTunes and iPod herein are to be construed as having equivalent applicability to other appropriate applications.

Methods and systems as described herein may be constrained by, but in compliance with, the legal and commercial requirements of the manufacturers that provide software applications on the one hand, and the rights-holders of content on the other. The design may be guided by and in compliance with these mandates. Conformity to the various licensing and terms-of-use covenants embodied in various forms, including those contained in end user license agreements (EULA) to which the end user or purchaser of subject content agrees, as well as to applicable US and International law. The methods and systems may comply with the security requirements that licensed DSP's typically agree to enforce as a condition of that license grant. These requirements, including common terms-of-use constraints such as limits on the permitted number of copies of the subject file to other locations, are commonly enforced by commercial DRM systems, such as seen in, but not limited to, Window Media DRM. These rules for consumption are typically embedded in DRM rule structures associated with, and delivered with, encrypted media.

Methods and systems as described herein may use the following techniques: (a) media file encoding and/or transcoding; (b) internal file transfer of media files, commonly known as “stream ripping”; (c) program-based automated, but possibly user-mandated, import of media files into an application, such as the commonly-employed practice of the creation of playlists in iTunes, or other media players, such that this importation is coupled with the concurrent importation of the subject media file itself, (d) user-level and network-level control elements of the invention's NRM; (e) combination of DRM functionality, such as seen in, but not limited to Window Media DRM, with methods cited in a) through d) above; and (f) combination of the methods cited in a) through e) above with elements of the Phoenix technology, (one such variation is offered by Passalong and is called “Freedom”), wherein activity within a user's computer is constrained at the level of the BIOS. This technique exerts control over user-initiated and program-initiated activity at the level of the machine-level microcode, with the result that under parameters mandated by a control scheme, (such provided by the invention's NRM and commercial DRM systems, as cited in (d) and (e) above), certain functions may be constrained. Examples may include network I/O capability for subject files, internal file transfer of subject files, and user and program access to subject files, such as cited in a), b) and c) above.

Secure multimedia sampler processing is also disclosed. The procedure allows secure playback of invention ‘try-before-you-buy’ sampler files. A number of sampler creation, playback, and protection methods have been cited in documents previously filed, methods that include system-level and client-level processing of a variety of media formats, such as MP3 and AAC audio encoding, as well as media types, such as video, video games, software, and the like. Thus, even though examples herein cite techniques as they apply to audio sampler files, the procedures described may apply, without loss of generality, to other media types controlled within the invention's NRM, including those cited in the Video Identification System (VIS).

The methods herein extend those previously cited to include an additional functionality wherein sampler files are dynamically processed at the invention's application client at run-time, but with the additional security provided by a Phoenix-enabled, BIOS-level configuration such as offered in Passalong's “Freedom” functionality. This enhancement allows the portion of the invention's NRM system that executes secure certificate-based control of sampler files in DRM super-distribution (previously cited), and the sampler file playback methods (also previously cited), either within the application or a licensed-enabled application, or an application that embeds this particular function as an API, or an application that embeds a set of API's, to execute the insertion of voiceovers, and to enable the delivery of the parameters that govern the characteristics of this insertion, under the aegis of a BIOS-level control system. Such a system is offered by Phoenix, and a relevant implementation of certain Phoenix-based functions is offered by Passalong Networks.

As described herein, client-level runtime execution may become secure to the level of the DRM system used to wrap the subject sampler file. Note, however, that this method may be generalized to include any signal processing technique that may be executed within the application and NRM. Thus, any technique wherein a client, or any application embedding API's, executes NRM-mandated modifications to a media file (or to the control extensions associated with that file) may be considered variations of this method of secure runtime processing. These procedures may extend previous embodiments of the creation and playback of, for example, sampler files to include a BIOS-level control system.

The specific technique described herein for client-level insertion of voiceovers is a particular instantiation of a set of algorithms that have been developed and implemented. The algorithms within this program have been reduced to practice and currently comprise the server-side sampler creation facility commercially offered.

The Secure Conversion Processing (SCP) technique may execute the conversion of DRM-wrapped content to a format that is compatible with, and/or is supported by, a target application. The assumption may be that the target application cannot, or does not, support the encryption and use-control structure of the subject media file. The SCP may preserve the rules mandated by the originating DRM system by providing secure transfer and processing for the subject file, and by limiting the way the file may be used once it's converted to the target format.

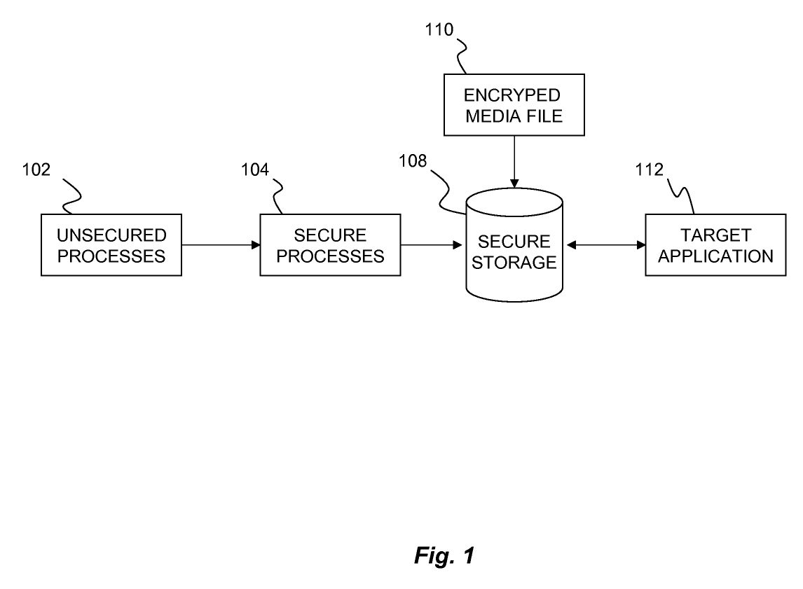

FIG. 1 shows the overall architecture of the preferred embodiment. The unprotected, unsecured processes 102 are transformed into secure processes 104 by secure invocation, and transferred to secure storage 108. The secure processes 104 and secure storage 108 are BIOS-level protected. Encrypted media files 110, which are DRM-protected objects, are then secure transferred into the secure storage 108. The secured processes 104 are then able to transcode the encrypted media file into a media file that is compatible with the target application 112. The new compatible file is then secure transferred to the unprotected target application 112.

Processes that interact with the SCP may invoke other processes that are secured through the BIOS-level control mechanism, such as implemented in the Phoenix-based technology offered by Passalong. The processes may be secured by ensuring in the BIOS control scheme that only the invention's application may invoke the process with specific commands. These commands may additionally be coded or signed to enhance security. Transfers of data to and from the secured processes may also be secure, and may be placed in a section of memory accessible only by permission of the control scheme, thus, the name “secure storage”. Finally, the results of the SCP may be available only to the target application and only certain actions may be permitted. In this way, the entire processing chain, and the related data, may be secured from unauthorized usage, including access to “in-the-clear” files, re-direction of data to unsecured processes and locations, invocation of the processes from non-SCP programs, and the like.

The preferred implementation of the SCP may deal specifically with Apple iTunes and the Apple iPod, but its procedures may be generalized to other similar platforms, wherein the media processing aspect of the platform may be incompatible with the native format of the original file, and where that original native format may be both encrypted and controlled by a DRM scheme that the target platform may not support.

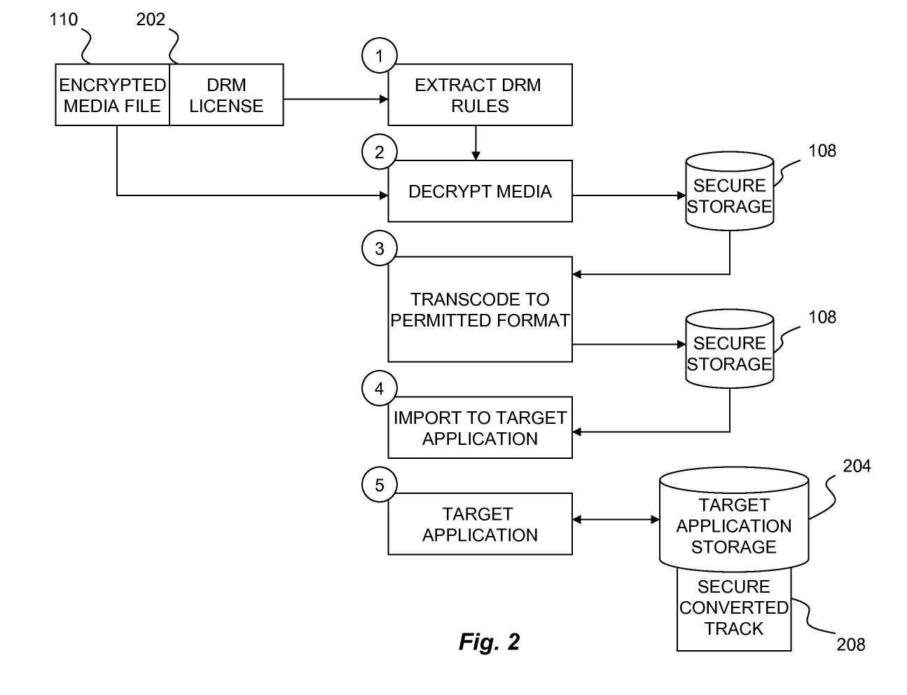

FIG. 2 shows the details of the top-level operation of the SCP. As shown in (1), the application may extract the DRM rules from the subject encrypted media file 110 and its DRM license 202. Note that this process may be general for all media files, but is described here in terms of audio files and the associated DRM. Specifically, the application may read the rules that detail the number of times the subject file may be copied to a logical location, such as to another computer or external portable device. In some systems, access to these rules and the file transfer may require an invocation of another process outside of the application.

In (2), if the transfer is permitted, the count governing the number of permitted copy-to-device operations may be decremented, and the media file may be decrypted using the associated DRM key provided with the file. The transfer of this data and the decryption process itself may be executed under security and according to the terms permitted in the BIOS-level security scheme used. The protected process may use secure storage 108 locations, which may be secured by the same method. Secure storage may be BIOS-level protected.

Once completed, as shown in (3), the decrypted media may be re-encoded into a format supported by the target platform. Again, this process may be subject to the BIOS-level security algorithm, as is the transfer to and from similarly protected secure storage 108.

The target application-compatible file may now be imported to the target application as shown in (4). The target applications of interest, which may be desktop media players, typically support import of compatible files, and may permit the creation of a playlist within which the imported file may be contained. In (5), this facility invoked, the file may be included into target application's media lists and stored in a target application storage 204. But, since access to the file may be controlled by the BIOS-level security mechanism, operations on this file may be limited and become a secure converted track 208.

In general, use may be limited to replay within the target application 112, but may also permit export to an associated device, provided that subsequent access to that file is controlled according to the original DRM rules. Thus, the file may not be burned to CD, stream-ripped or shared onto networks; its use may be strictly limited to replay within the target application 112, and possibly, to copying to a logical device.

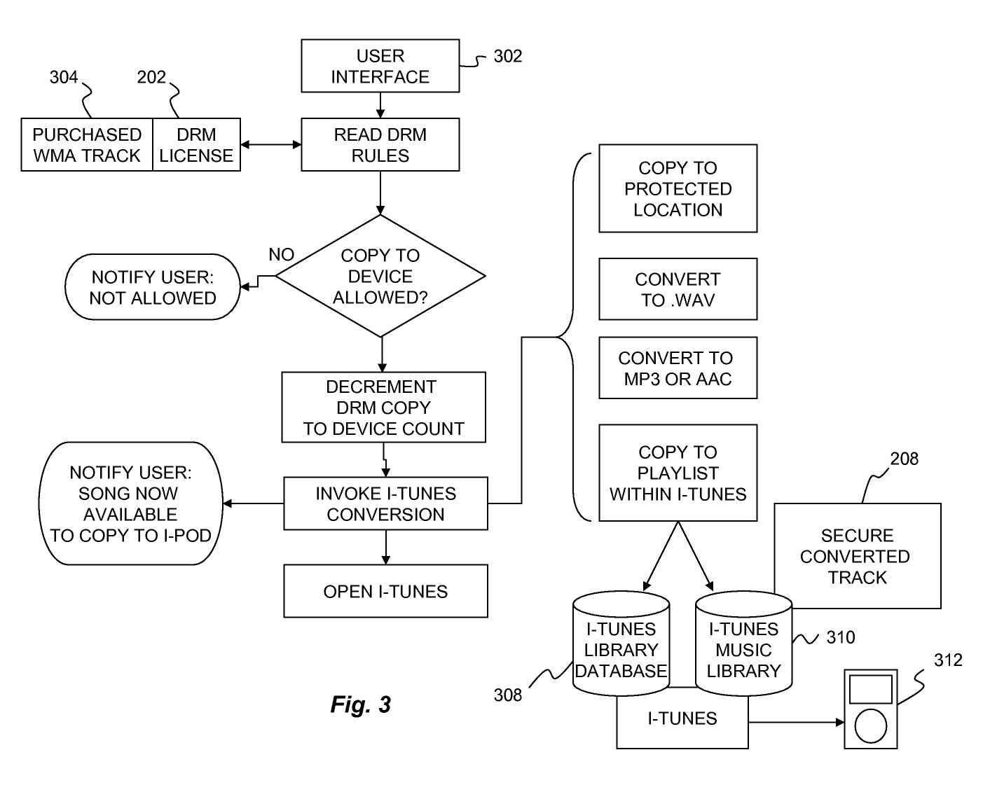

FIG. 3 details the SCP as it applies to the widely used program iTunes from Apple Computer and the handheld music player iPod, also provided by Apple Computer. When a user, through a user interface 302, designates a file for conversion using SCP, the relevant DRM copy-to-devise rules are read from the purchased WMA track 304 and its DRM license 202. Typically, the subject file may be wrapped in Windows Media DRM, but it is understood that other formats may be accommodated as well. Logic may be applied to the rules, and if the file is indeed copied, the DRM copy-to-device count may be decremented.

In this particular implementation, within the BIOS-level security system, the file may be converted to PCM (in Windows, this is also known as .wav), and may then be secure-encoded into an open format such as MP3 or AAC. Other formats may be used as well. Again, within the BIOS-level security system, the file may be imported into iTunes, using commonly accessible methods for compatible file import. The file may also be included in a playlist within the user's iTunes library database 308 and/or iTunes music library 310.

Once this process is complete, the file may be inaccessible to any application but iTunes, protected as described herein. But a user may copy the file to an Apple iPod 312 because, as a part of its security system, this process may be one-way: Apple may not permit uploading files from an iPod 312 to a hard drive.

Thus, in compliance with the applicable DRM rules, and with the digital millennium copyright act (DMCA) provisions governing circumvention of security programs, the file may be legally imported into iTunes, may only be played in iTunes, and may be copied only to a user's iPod; it may not be burned to a CD or otherwise moved, accessed or manipulated. Further, since the BIOS-level security system may monitor this transfer, every instance of such a transfer may be detected; the DRM counts may be decremented, and the transfer prevented when the count is exhausted.

In one variation on this method, media files purchased from Apple and encrypted under Apple's DRM, known as Fairplay, may be converted for use in other applications, provided the applications are able to be controlled under the BIOS-level security system.

In the preferred embodiment, the secure sampler processing (SSP) allows the client application to insert voiceovers 402 into an audio program, and to optionally band-limit the playback of that program during the playback of that file. Just such a method is cited in documents filed previously that detail methods related to sampler processing. This extension may include a secure processing layer using a BIOS-level control system that limits the access to the process, to the parameters that the process uses to execute its functions, and to the data the process generates.

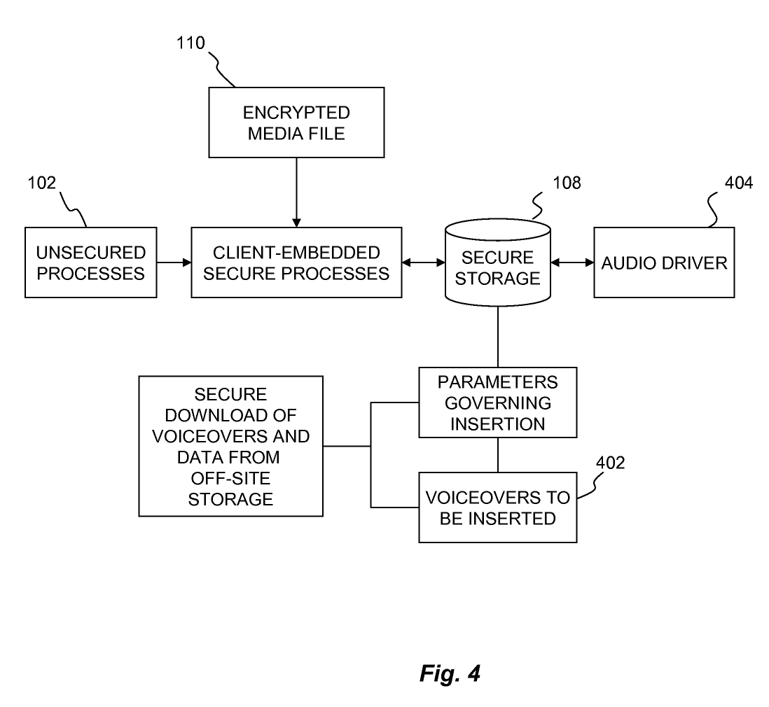

FIG. 4 shows the top-level architecture of the SSP process. Client-embedded secure processes may be executed under permissions granted by a BIOS-level control system. These processes may include the signal processing required to insert the voiceovers 402 into the sampler file during playback, as well as the process by which the voiceovers 402 themselves, and the parameters that govern their insertion, are obtained. The mechanisms that obtain the license for this playback and the NRM-based certificate exchanges that enable sampler play may remain unaffected.

In the preferred embodiment of the SSP, the BIOS-level control system may be configured to permit the client to access the subject voiceovers 402, as well as the insertion parameters. These files may be cached locally and protected, but may be obtained at any time under a secure download (secured by the BIOS-level control system); obtained either asynchronously and, in relation to playback, cached; obtained during playback and downloaded during runtime; or obtained at the time of playback initiation. That is, during the exchange of certificates when a user initiates sampler play.

Note that variations to the preferred embodiment may include extending BIOS-level control to the sampler file itself, thereby limiting access of the file to the application. Further, note that the sampler media file may be any content protected and governed by the NRM, including video, video games, software, and the like. In this sense, the security of the NRM control fabric and its related VIS system may be enhanced globally by including all or part of its functionality within the BIOS-level control rubric. Thus, the SSP may be seen as a specific implementation of a generalized extension, subsuming all of part of the invention's NRM and its component pieces, including the client itself and all its communications with outside servers.

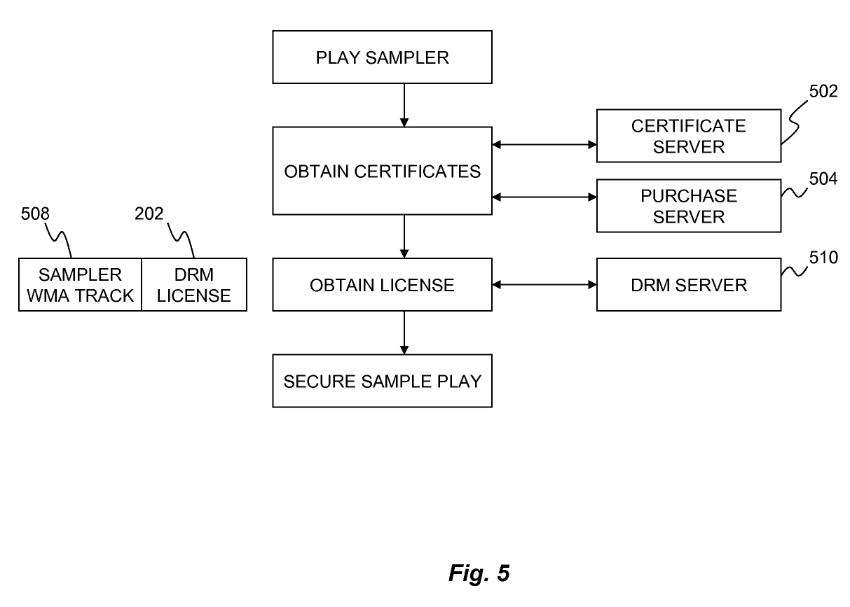

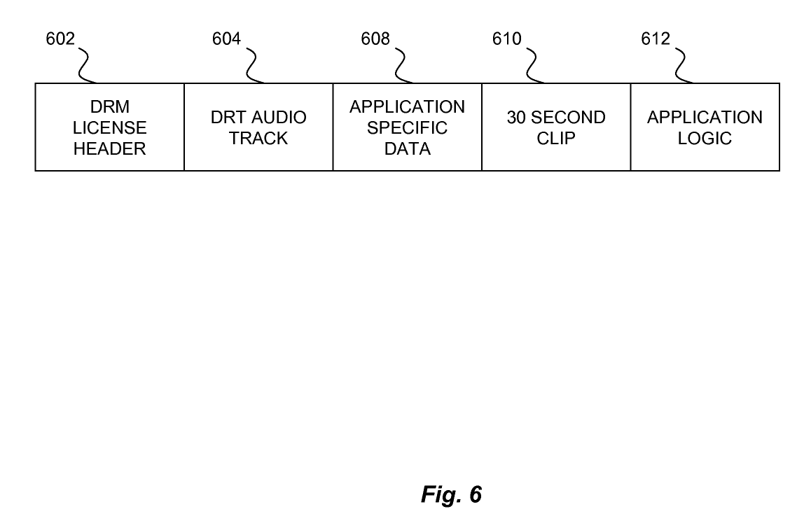

Noting this generality, FIG. 5 shows details on how this extension applies to the invention's NRM processes related to sampler play. In the specific case of audio sampler playback, the user selects a sampler file for replay. The processes that obtain the permission to replay that track include communication with the attendant certificate server 502, purchase server 504, and DRM server 510, that are operated or affiliated with the invention's application. The actual documents exchanged, may be secured under the BIOS-level security aegis, though this extension may not be required. Licenses are obtained from the sampler WMA track 508 and its DRM license 202. In this embodiment, the sampler may be a composite file, such as shown in FIG. 6, except that, in this instance, the file includes only 30-second clips, and other information that may be displayed to the user when the file is played. The composite file may contain a DRM license 602, encrypted WMA DRT audio track 604, application specific data 608, unencrypted WMA 30 second clip 610, application logic 612, and the like. The application specific data 608 may include album art and other information on the track or art list. The application logic 612 may include data required by the application to enable or enhance sampler play.

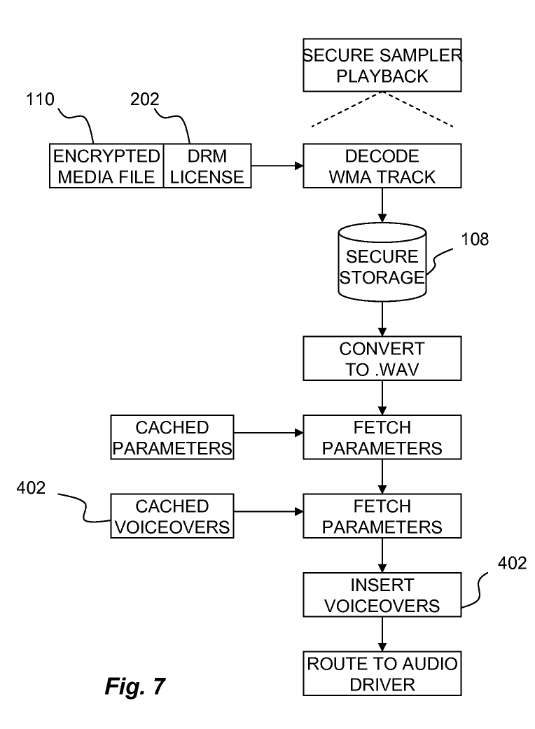

FIG. 7 details the steps in the insertion of the voiceover 402 into an audio sampler file. Following user selection of the play function, the NRM may obtain permission to play the track, and may download a license to decrypt the file. Following decryption, the file may be routed to the associated codec where it may be converted to PCM format, or to the functional equivalent in Windows, known as .wav. The PCM-formatted file may be stored in a secure storage 108, or accessible in memory only by designated processes designated through the BIOS-level security system. The application may fetch the voiceovers 402 and the parameters that govern their insertion. Following this process, the file may be routed to the resident audio driver, a low-level process that is designated by the BIOS-level security system as permitted to receive this data.

The end-to-end result may be that the signal processing and the surrounding support processes are secure against attempts by a non-secure process, or by someone using a manual technique, to block, change, or otherwise manipulate the voiceovers 402 inserted during playback of the sampler.

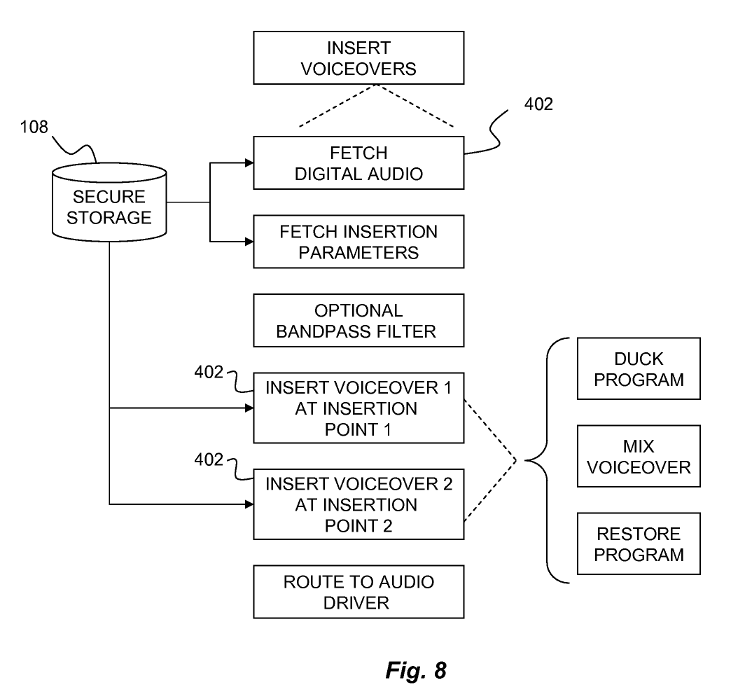

FIG. 8 details the signal processing steps in the insertion of the voiceovers 402. Note that this is only one possible implementation and there are many variations, such as inclusion of the signal processing algorithms and the supporting functions within a type of driver interposed between the codec output and the input of the resident audio driver, or embedding of the net functionality of the insertion functions within a “filter” dynamically placed, or placed and dynamically activated, within a codec such as Windows Media Player.

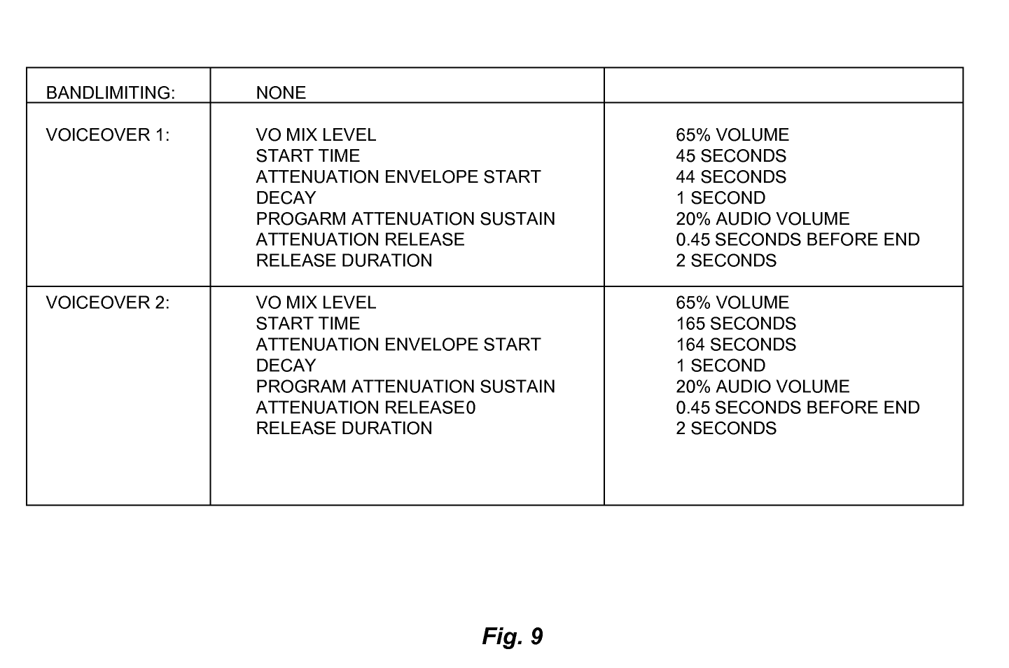

Once the PCM audio is available, the client may fetch the parameters that govern the insertion of the voiceover 402. The converted PCM and the parameters may be stored in a memory location that may be protected by the BIOS-level security system in such a way that the location and/or the data itself may be accessible only by permitted processes. FIG. 9 provides an example of the parameters that govern sampler voiceover insertion.

The elements depicted in flow charts and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these, and all such implementations are within the scope of the present disclosure. Thus, while the foregoing drawings and description set forth functional aspects of the disclosed systems, no particular arrangement of software for implementing these functional aspects should be inferred from these descriptions unless explicitly stated or otherwise clear from the context.

Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods or processes described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

1. A method comprising:
receiving a source digital file that is protected with a digital rights management facility;
converting the digital file into a file format suitable for use by a target application that is different from the original file format of the source digital file and that does not support the digital rights management facility of the source digital file; and
associating the file conversion process with a secure processing facility that is supported by the target application.

2. The method of claim 1, wherein the target application does not support the structure of the digital file before conversion.

3. The method of claim 2, wherein the secure processing facility is an encryption structure.

4. The method of claim 2, wherein the secure processing facility is a use control structure.

5. The method of claim 1, wherein the conversion preserves the rules mandated by the digital rights management layer of the digital file before conversion.

6. The method of claim 5, wherein the conversion preserves the rules by providing secure transfer.

7. The method of claim 6, wherein the transfer is of the digital file before conversion.

8. The method of claim 5, wherein the conversion preserves the rules by providing secure processing.

9. The method of claim 8, wherein the processing is of the digital file before conversion.

10. The method of claim 5, wherein the conversion preserves the rules by limiting the usage of the digital file after conversion.

11-30. (canceled)

31. A system comprising:
a source digital file that is protected with a digital rights management facility; and
a conversion facility for converting the digital file into a file format suitable for use by a target application that is different from the original file format of the source digital file and that does not support the digital rights management facility of the source digital file, wherein the file conversion process is associated with a secure processing facility that is supported by the target application.

32. The system of claim 31, wherein the target application does not support the structure of the digital file before conversion.

33. The system of claim 32, wherein the secure processing facility is an encryption structure.

34. The system of claim 32, wherein the secure processing facility is a use control structure.

35. The system of claim 31, wherein the conversion preserves the rules mandated by the digital rights management layer of the digital file before conversion.

36. The system of claim 35, wherein the conversion preserves the rules by providing secure transfer.

37. The system of claim 36, wherein the transfer is of the digital file before conversion.

38. The system of claim 35, wherein the conversion preserves the rules by providing secure processing.

39. The system of claim 38, wherein the processing is of the digital file before conversion.

40. The system of claim 35, wherein the conversion preserves the rules by limiting the usage of the digital file after conversion.

41-60. (canceled)
